(19) United States
(12) Patent Application Publication
(10) Pub. No.: US 2025/0264068 A1
(43) Pub. Date: Aug. 21, 2025

(54) Operating Modes for Two-Cycle Uniflow-Scavenged Diesel Engine

(71) Applicant: Yelir, Inc., Fort Collins, CO (US)

(72) Inventors: Michael B. Riley, Fort Collins, CO (US); John Craig Hedrick, Boerne, TX (US); Steven Gerard Fritz, La Vernia, TX (US)

(21) Appl. No.: 18/442,233

(22) Filed: Feb. 15, 2024

(51) Int. Cl. F02D 41/00; F02D 29/04

(52) U.S. Cl. CPC F02D 41/005; F02D 29/04; F02D 2200/021

(57) ABSTRACT

Methods of operating a two-cycle uniflow-scavenged engine, especially at lower loads. The exhaust valves of one or more of the engine's cylinders may undergo exhaust valve deactivation (EVD), that is, a cylinder's exhaust valve is activated with a frequency that is less frequent than every engine cycle. EVD may be combined with additional engine operating strategies, such as by using fewer than all cylinders as combusting cylinders and adjusting airflow and fueling to combusting cylinders.

### TECHNICAL FIELD OF THE INVENTION

This invention relates to two-cycle diesel engines with uniflow scavenging, and more particularly to improving their performance with various operating modes.

### BACKGROUND OF THE INVENTION

The EMD engine, manufactured by Electro-Motive Diesel (now Progress Rail, a Caterpillar Company), is an example of a two-stroke uniflow-scavenged diesel engine. It is a medium-speed engine, used in locomotive, marine, and stationary power applications. The engine comes in a 567, 645, and 710 Series, each number representing the displacement in cubic inches of each cylinder, and is made in V-8, V-12, V-16, and V-20 configurations, ranging in power from 600 to 5000 bhp. Most locomotive production has been the V-12 and V-16 versions of the engine.

The “uniflow-scavenged” feature of such engines requires an external air pump to provide differential air pressure across the cylinders. This air pressure allows the engine to be scavenged correctly, replacing combustion exhaust gases with fresh air.

For an EMD engine, two different air pump systems have been used for scavenging. A “naturally aspirated” engine typically has a two gear-driven Roots-type blowers that mechanically scavenge the cylinders. A “forced induction” EMD engine uses a “turbo-supercharger”, which drives the forced induction system mechanically at low power operating modes. The gear-driven turbocharger provides the required air flow at idle and light-to-moderate loads, thus acting like a supercharger. At higher loads, once the exhaust energy is high enough to sustain the turbocharger, an overriding clutch releases and the turbocharger “comes off the gear”, operating as a freewheeling turbocharger, maximizing engine efficiency.

A characteristic of this type of engine is relatively low exhaust temperatures at low loads due to extremely high air/fuel ratios, often over 300:1. These low exhaust temperatures adversely affect catalyst-based exhaust aftertreatment systems, which are typically designed to be most effective at higher exhaust temperatures. Various methods have been proposed to improve low-load exhaust temperatures in diesel engines to enhance the effectiveness of catalytic aftertreatment systems. Such systems include hydrocarbon dosers with a diesel oxidation catalyst (EP2179148B1), late injection in-cylinder to increase late burn (U.S. Pat. No. 6,412,276), diesel burners in the exhaust to burn diesel fuel directly in the exhaust stream (U.S. Pat. Nos. 4,318,887, 4,731,994, 5,826,428, 7,032,376), and electrical heating elements in the exhaust stream (U.S. Pat. No. 5,582,805). A shortcoming of these methods is that fuel economy is worsened by burning fuel that contributes little or nothing to the power output of the engine, while at the same time increasing carbon dioxide emissions.

U.S. Pat. Nos. 10,837,385 and 11,333,091, assigned to Michael B. Riley, are directed to “rebreathing” methods for improving performance of two-cycle uniflow-scavenged diesel engines. Rebreathing is achieved through exhaust valve deactivation (EVD) of selected cylinders and is used at low engine loads when there is an excess of oxygen relative to the amount of fuel injected in a normally operating two-stroke, uniflow-scavenged engine. Using EVD, it may be possible to inject fuel over several cycles without refreshing the air in a cylinder, that is, by “rebreathing” the air. In other words, when a cylinder is rebreathing, its exhaust valve(s) are deactivated.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a representative drawing of an example of a two-cycle uniflow-scavenged diesel engine, which is equipped for exhaust gas temperature assist in accordance with the invention.

FIG. 2 illustrates a method of increasing exhaust gas temperatures at lower loads, for an engine such as the engine of FIG. 1.

FIG. 3 illustrates an example of a two-cycle uniflow-scavenged diesel engine, having variable turbocharger compressor output.

FIG. 4 illustrates a method of increasing exhaust gas temperatures at lower loads, for an engine such as the engine of FIG. 3.

FIG. 5 illustrates another example of a two-cycle uniflow-scavenged diesel engine, having a supercharger with variable compressor output, and suitable for use with the method of FIG. 4.

FIG. 6 illustrates an engine like that of FIG. 1 but having a compressor whose output may be bled off upstream the intake manifold.

FIG. 7 illustrates an engine like that of FIG. 1, but having a variable speed electric motor to drive the compressor.

FIG. 8 illustrates an engine like that of FIG. 5, but having a variable speed electric motor to drive a supercharger rather than a turbocharger.

### DETAILED DESCRIPTION OF THE INVENTION

As stated in the Background, U.S. Pat. Nos. 10,837,385 and 11,333,091 describe various methods of exhaust valve deactivation (EVD), which means activating exhaust valves with less frequency than normal engine operation every engine cycle. These methods result in cylinder “rebreathing”, such that a cylinder operates over more than one engine cycle without refreshing the air in the cylinder. These patents are incorporated by reference herein.

As a simple example of rebreathing, an engine with all cylinders having EVD for X consecutive cycles will have essentially the same amount of fuel injected during each of X cycles before the exhaust valves are operated to release the combustion products, but the volume of air passed through the engine will be approximately 1/X of the normally operating engine. The engine receives the same amount of fuel with less air. An advantage of rebreathing is to increase exhaust gas temperatures, thereby enabling catalytic aftertreatment.

The following description is directed to particular EVD modes for operating a two-cycle uniflow-scavenged diesel engine. These modes are useful when exhaust temperatures are below a predetermined threshold. In particular, EVD can be used in an “Air Spring Mode” or an “Internal Exhaust Gas (EGR) Mode”, both described in detail herein.

The invention is useful for transportation applications (locomotive and marine), which operate with varying engine speeds and load conditions. It is also useful for power generation applications, where engines run at a constant or synchronous engine speed and simultaneously with a generator to produce alternating current power at various loads. These engines also suffer from low exhaust temperatures at low loads. It should be assumed herein that the term “engine” is used herein to mean the above-described types of engines, that is, two-cycle uniflow-scavenged engines.

### Overview of Two-Cycle Uniflow-Scavenged Diesel Engine

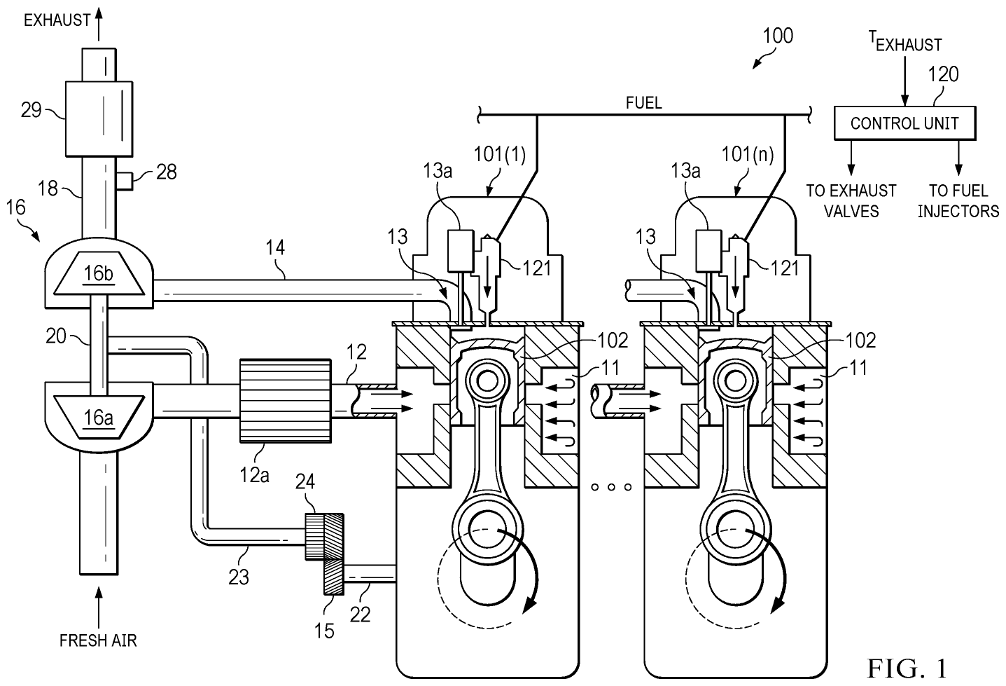

FIG. 1 schematically illustrates an example of a two-cycle uniflow-scavenged diesel engine 100 in accordance with one embodiment of the invention. Engine 100 is a forced induction engine, having a turbo super-charger 16. As stated in the Background, an example of such an engine is an EMD engine.

Only those parts of engine 100 relevant to the invention are shown. It can be understood that a production engine has many additional electrical and mechanical elements that are typically associated with such an engine.

For purposes of example herein, engine 100 is a 16-cylinder engine. This engine has been and continues to be commercially available as the EMD 645 and 710 Series engine and is available with more or fewer cylinders. The multiple cylinders 101 are represented in FIG. 1 as cylinders 101(1)-101(n). The size of the engine and the number of cylinders may vary.

For locomotive applications, the throttle notch system of engine 100 is designed with a number of steps, referred to as “notches”. Position 1 (Notch 1) is the lowest powered setting where electrical power is delivered to the traction motors. Position 8 (Notch 8) is maximum rated engine speed and the position where maximum power is available.

Fuel is supplied via fuel injectors 121, each cylinder 101 having an associated fuel injector 121. As described below, fuel delivery is individually controlled to each cylinder 101. The amount of fuel delivered may be varied among cylinders 101 using electronic fuel control means such as pulse width modulation.

Each cylinder 101 has an intake plenum 11, which transfers air into cylinder 101 when intake transfer ports in the cylinder liner are uncovered by a piston. Intake plenum 11 receives intake air via an aftercooler 12a and intake manifold 12.

An exhaust valve 13 in the cylinder head expels exhaust from the cylinder 101 to an exhaust manifold 14. The operation of exhaust valve 13 is activated or deactivated by an exhaust valve actuator 13a. Although this description is in terms of cylinders each having a single exhaust valve, the same concepts apply to cylinders having multiple exhaust valves.

For the engine described herein, control of each exhaust valve 13 is “active” in the sense that the opening and closing of exhaust valve 13 can be controlled with control signals. This is in contrast to conventional EMD two-stroke engines, in which the exhaust valves are cam-actuated every engine cycle and cannot be controlled variably.

It should be understood that both the intake manifold 12 and exhaust manifold 14 are illustrated in a representative manner and serve additional cylinders 101 of the engine. A turbo-supercharger 16 is conventional for production EMD engines and has a compressor 16a and turbine 16b. Turbo-supercharger 16 may be gear-driven with a gearbox 15 and overriding clutch 24. The gearbox 15 transmits rotary motion and torque from shaft 22 to shaft 23 and to compressor shaft 20. The overrunning clutch 24 ensures that rotary motion and torque are transmitted in one direction only.

Gearbox 15 and overrunning clutch 24 drive the compressor 16a during idle and at lower engine loads, when exhaust gas energy is insufficient to fully drive compressor 16a connected to turbine 16b. During this time, compressor 16a is “mechanically driven”. At higher loads, increased exhaust gas temperature and mass flow, and thus enthalpy, is sufficient to drive the turbine 16b, and clutch 24 disengages, such that turbocharger 16 is “off gear” and is “exhaust-driven”.

As described below, in other embodiments, compressor 16a may be driven by other mechanical configurations. For example, compressor 16a may be driven without an overriding clutch. Or compressor 16a may be driven with an electric motor or a transmission.

Compressor 16a compresses intake air, which then passes through aftercooler 12a before entering intake plenum 11. When exhaust gas leaves cylinder 101 via exhaust valve 13, the exhaust gas enters turbine 16b. From turbine 16b, exhaust gas exits via exhaust pipe 18 and is delivered to aftertreatment system 29. An exhaust temperature sensor 28 to measure exhaust gas temperature may be used, and if so is typically placed near the inlet to the exhaust aftertreatment system 29. A characteristic of engine 100 is a transport delay between any engine notch or valve operation change and temperature measurement at sensor 28. Control unit 120 has a means for storing or estimating this transport delay. Air mass flow changes with notch level and exhaust valve operation, so a time delay is necessary to ensure that sensor 28 responds appropriately.

In other embodiments, the exhaust aftertreatment system may be positioned before the turbine. In this case, the temperature measurement would still occur before the aftertreatment system.

The methods described herein are not limited to engines having a turbo-supercharger. They may be useful for other engines (two-cycle uniflow-scavenged), such as engines having superchargers or blowers or conventional turbochargers.

### Standard Mode

When all cylinders are in Standard Mode, the engine's load level is high enough during normal operation such that exhaust temperatures are adequate for catalytic aftertreatment. In locomotive applications, Standard Mode typically occurs above Notch 4.

More specifically, when all cylinders are in Standard Mode, the engine has the following characteristics. 1) Exhaust temperatures are above a preset threshold. 2) All cylinders are combusting and all exhaust valves are operating normally, e.g., no exhaust valve deactivation (EVD). 3) All cylinders receive the same fueling. 4) Fuel injection, combustion, and exhaust valves operate on every crank revolution.

Under various operating conditions, one or more cylinders may switch from Standard Mode to some alternative mode, which may involve EVD or other adjustments. Two alternative modes, Air Spring Mode and an Internal EGR (exhaust gas recirculation) Mode are discussed below. In general, when a cylinder is operating in one of these alternative modes, it operates with EVD and/or fueling adjustments.

These alternative modes are used when the exhaust temperature is “below threshold”, to raise exhaust temperatures. “Below threshold” is typically at Notch 4 or below.

However, these alternative modes may optionally be used when exhaust temperatures are “above threshold”. “Above threshold” is typically above Notch 4, that is at Notches 5-8. During above threshold conditions, the alternative modes may be used for operating benefits such as reduced emissions or fuel economy, particularly at the lower end of “above threshold”. For example, at Notch 5, it may be advantageous to operate with 12 of 16 cylinders in Standard Mode and the remaining cylinders in Air Spring or Internal EGR Mode.

The exhaust temperature threshold is predetermined. The determination of whether the exhaust threshold is exceeded may be made by measurement or by reference to stored data, such as a look-up table.

### Overview of Exhaust Valve Deactivation

This section provides a basic description of EVD for two-cycle diesel engines with uniflow scavenging. The description is “basic” in the sense that it describes EVD, but various fuel adjustment and cylinder selection strategies that may be used in conjunction with EVD are discussed below in subsequent sections.

During EVD, a cylinder's exhaust valve 13 activates (open) to release exhaust gas at a lower frequency than every engine cycle (one engine cycle being one revolution for a two-cycle engine). This lower frequency is accomplished by “deactivating” exhaust valves 13 so that they do not open during a predetermined pattern of engine (combustion) cycles. As one example, a cylinder's exhaust valve 13 may be deactivated every other engine cycle, which effectively halves the exhaust gas flow from that cylinder 101 compared to if its exhaust valve 13 were to open every engine cycle.

By not exhausting gases in a cylinder 101, the air and exhaust products in the cylinder 101 are at an elevated temperature. On the next engine cycle, if fuel is injected, the exhaust temperature will rise further. When exhaust valve 13 is opened, the exhaust gas will be hotter than if the exhaust valve were opened (activated) on every engine cycle.

EVD may be implemented for all of an engine's cylinders or for a selected subset of the engine cylinders.

As a more generalized description of EVD with all engine cylinders participating, exhaust valves 13 are activated M out of N combustion cycles, with M and N being integers, and M less than N. For example, if M were 1 and N were 4, then exhaust valves 13 would be activated (and breathe) every four engine cycles, and the engine would have EVD (“rebreathe”) for the other three engine cycles. Generally, the lower the load, the more engine cycles can occur with EVD.

EVD may be implemented with control unit 120. It is assumed that control unit 120 has appropriate hardware and software, configured and programmed to perform the process described herein. Temperature thresholds may be pre-programmed and stored. Control unit 120 may be part of a more comprehensive control system-only those inputs, outputs, and processes relevant to the invention are described herein.

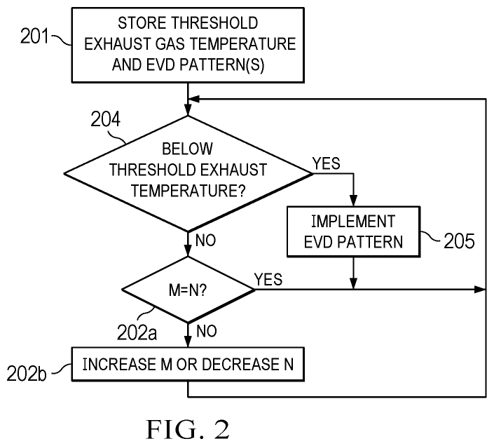

FIG. 2 illustrates a method of using EVD for exhaust gas temperature assist, for an engine configured as in FIG. 1. It is assumed that the engine has a control unit, such as control unit 120, for performing the method. Control unit 120 is programmed to receive the input data referred to below, and to generate control signals to the exhaust valve actuators 13a and to fuel injectors 121.

Step 201 is storing a threshold exhaust gas temperature value, and at least one exhaust valve deactivation (EVD) frequency pattern in control unit 120. These values are stored in memory of control unit 120. The conditions under which EVD is implemented may be predetermined and stored as a look-up table or other data.

The exhaust gas temperature threshold value represents a temperature below which exhaust gas temperatures require a temperature assist for the exhaust aftertreatment system 29 (FIG. 1) to be optimally effective. The threshold value may vary with the particular engine and expected operating conditions, but it is expected that this threshold will be the load level at Notch 4 (mid load), such that temperature assist of the method of FIG. 2 will be performed at or below that load level. For purposes of this description, load levels below this threshold may be referred to as “mid to low load levels” including idle and dynamic brake. Because the load level may be representative of exhaust gas temperature, in some embodiments, the threshold may be in terms of load levels, which may be considered an equivalent for purposes of measuring or estimating exhaust gas temperatures.

The EVD frequency patterns are one or more patterns of exhaust valve deactivation/activation. As explained above, a ratio M/N, which represents a number of engine cycles in which the exhaust valves are activated (M) relative to a number of normal engine cycles (N). In other words, the engine “breathes” only M cycles of every N combustion cycles and operates with EVD for N minus M cycles. The “rebreathing” cycles are cycles in which the exhaust valves are deactivated.

Step 204 is a decision step that determines if the engine is operating in “below threshold” conditions. This condition may be determined dynamically or from stored data.

If the current exhaust temperature is at or above the threshold temperature, Step 202a is comparing the number of breathe cycles (M) relative to the number of combustion cycles (N). If M is equal to N, the process returns to monitoring the exhaust gas temperature (Step 203) and engine operation continues with normal combustion cycles and without exhaust temperature assist. Typically, in normal exhaust valve operation, the exhaust valves 13 are activated every cycle. This is referred to herein as operating the engine with “normal exhaust valve activation”. However, if M does not equal N, in Step 202b, M is incremented or N is decremented. Typically, the increment is by 1 or decrement is by 1, respectively, but other patterns are possible.

In Step 205, if the current exhaust temperature is below the threshold value, control unit 120 determines an EVD pattern, e.g., a number of “breathing” cycles relative to normal combustion cycles. This determination may be made using a lookup table or an algorithm. A combination of engine speed and load along with exhaust temperatures might be used dynamically, or it may be pre-programmed where lookup tables are used based on ambient temperature conditions, engine coolant temperature, engine lubricant temperature and engine speed and load. Different current exhaust gas temperatures and different load levels may be associated with different EVD patterns.

The process returns to Step 204 to monitor engine conditions. As the exhaust temperatures rise to the threshold level, the same or a different EVD pattern may be employed. Once the exhaust gas temperature reaches the threshold level, the engine continues the existing EVD patterns unless there is a load change, or a preselected time limit moves the EVD pattern around different cylinders to ensure uniform thermal loading.

### Exhaust Temperature Assist, Using Exhaust Valve Deactivation and Reduction of Intake Manifold Pressure

The temperature assist of the above-described method, performed at lower loads using EVD, can be enhanced if the engine has a compressor whose output can be controlled. As explained below, a compressor having this capability can be used to reduce intake manifold pressure and further increase exhaust temperatures and reduce fuel consumption.

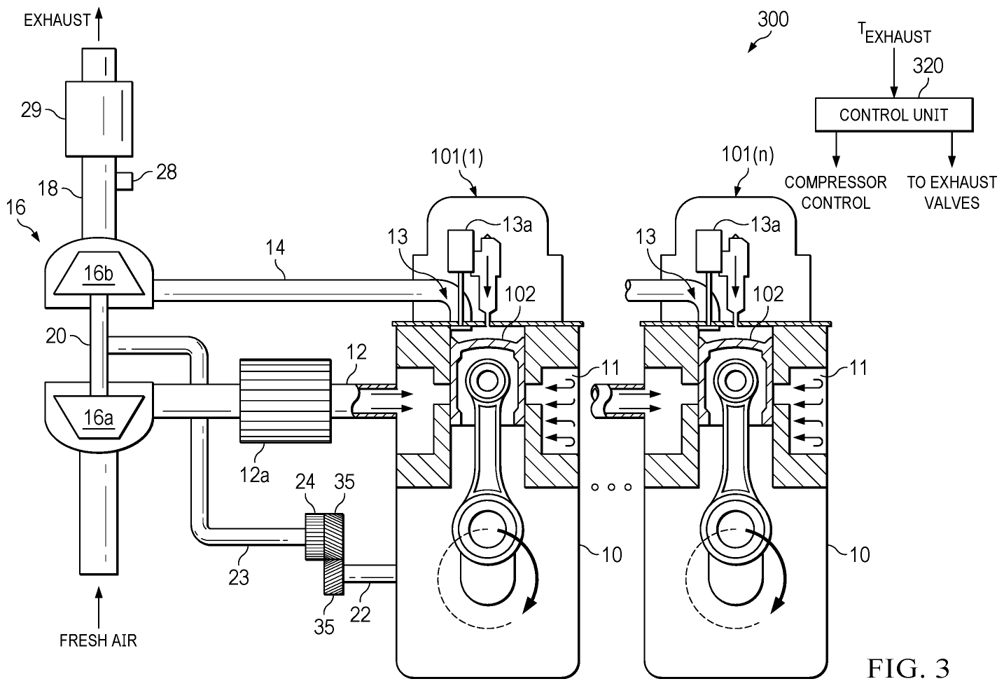

FIG. 3 illustrates a modification of the embodiment of FIG. 1, an engine 300 in which gearbox 15 is replaced with a variable transmission 35. This allows compressor 16a to operate at different speeds at a given engine speed and allows control of intake manifold pressure. The variable transmission may be of various types, such as a stepped or continuously variable transmission.

For exhaust temperature assist at lower loads, the engine of FIG. 3 is operated in a manner similar to that of FIG. 1, but with an added feature of compressor output control. In a uniflow two-stroke engine, there is an overlap period when piston 102 is close to the bottom of its stroke, and the intake ports are uncovered at the same time that the exhaust valves 13 are open. During this overlap period there is direct communication between the intake plenum 11 and the exhaust system, allowing some intake air to scavenge through cylinder 101. Intake manifold pressures under normal idle, dynamic brake, and low load conditions push excessive amounts of fresh air through cylinder 101 during this time. This excessive amount of scavenge cools the exhaust gas flow and requires mechanical compressor work that consumes additional fuel.

A feature of the invention is the recognition that if the intake manifold air pressure is reduced, the excessive short-circuit fresh air flow is reduced, and a higher exhaust gas temperature is maintained and fuel consumption is reduced. This can be accomplished by reducing the speed of compressor 16a.

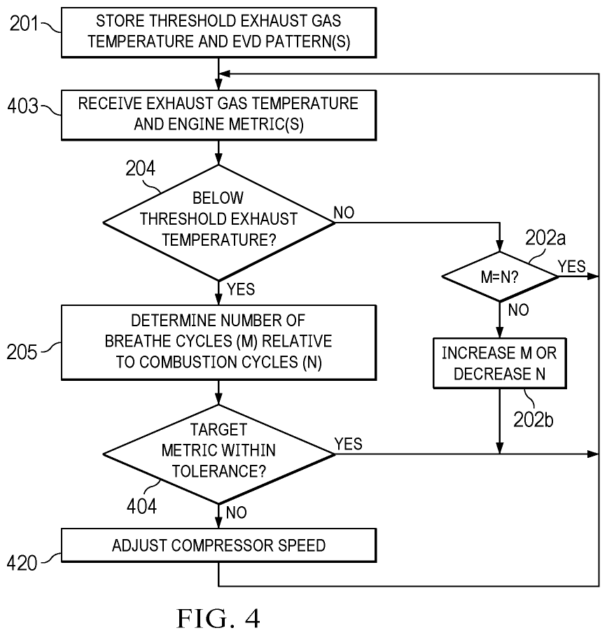

FIG. 4 illustrates a method of operating the engine of FIG. 3 for exhaust temperature assist at lower loads. At lower loads, turbo-supercharger 16 is “on gear”, with the compressor 16a driven mechanically and not fully or exclusively by the exhaust-driven turbine 16b.

The steps of the method of FIG. 4 are similar to those of FIG. 2, except that one of several additional engine metrics may be used to control the speed of compressor 16a. These metrics may include intake manifold pressure, differential pressure between the intake and exhaust manifolds, or overall engine air/fuel ratio, as measured by oxygen content in the exhaust. Additional step 404 compares the engine metric with a set tolerance band. If the metric is within the tolerance band then the control system returns to monitor exhaust gas temperature and the chosen metric in Step 403. If the metric is outside the tolerance band then the speed of compressor 16a is adjusted to achieve the tolerance band. As described above, this has the effect of further increasing exhaust gas temperature as well as reducing compressor work and therefore reducing fuel consumption.

For the method of FIG. 4, control unit 120 is programmed similarly to that of FIG. 2, with the additional feature of generating control signals to the transmission of the compressor.

Referring again to FIG. 3, variable transmission 35 is used to reduce the speed of shaft 23 to compressor shaft 20. However, the same method may be used with any other two-stroke uniflow-scavenged engine having a means for controlling the intake manifold pressure.

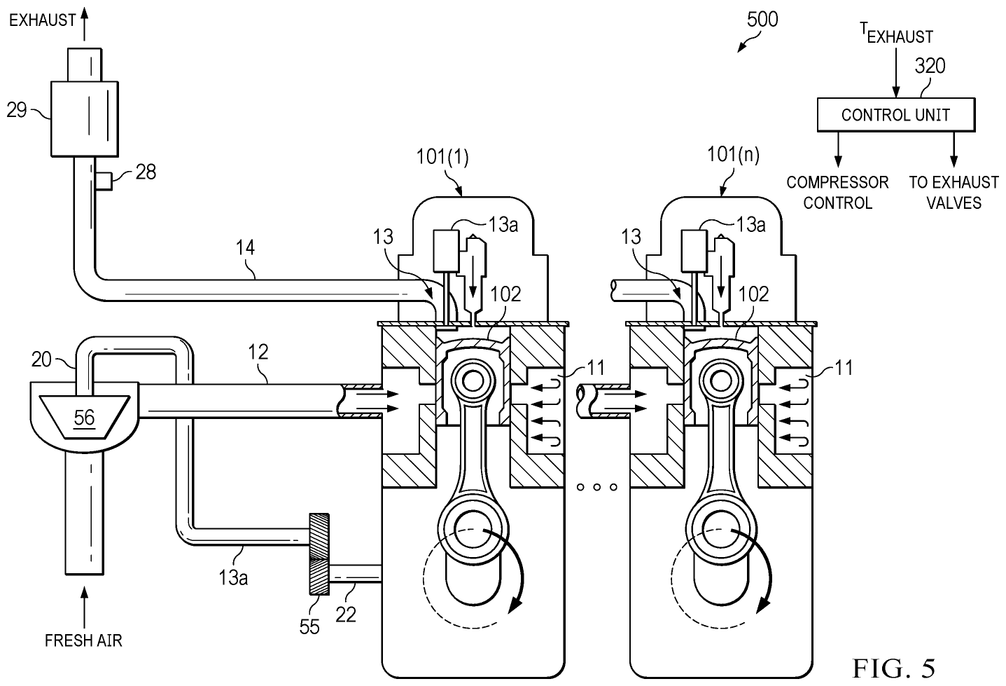

FIG. 5 illustrates a two-cycle uniflow-scavenged engine 500, having a supercharger 56. A variable transmission 55 allows the output of supercharger 56 to be controlled. This assumes that supercharger 56 has more airflow output than is necessary to provide forward flow into the intake manifold and through the engine.

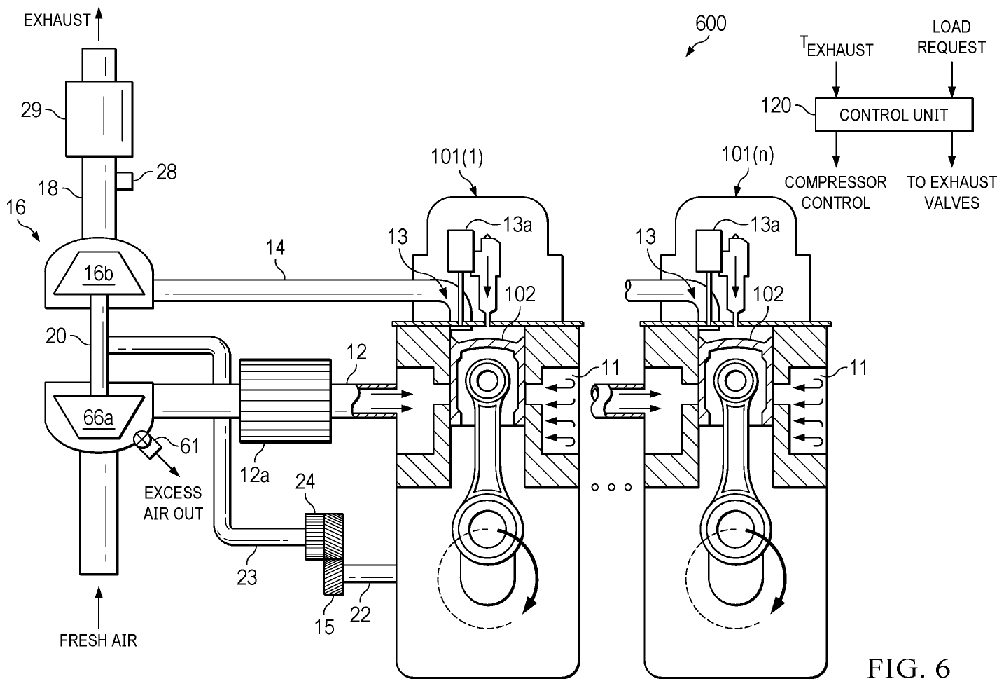

FIG. 6 illustrates an engine 600 like that of FIG. 1, but having a compressor 66a whose output may be bled off upstream of the intake manifold, or other means for bleeding off intake air. In the example of FIG. 6, this is achieved with a bleed port and valve 61. For this engine, at lower loads, the method of FIG. 4 may be used, but with intake manifold pressure reduced by bleeding off intake air rather than by reducing compressor speed, which will assist in increasing exhaust gas temperature. Control unit 120 is programmed to generate appropriate control signals to a valve or other means for controlling bleed off.

It is to be understood that exhaust temperature assist by means of deactivating exhaust valves can be performed with any of the engines described herein, and perhaps others. Exhaust temperature assist by means of reducing intake manifold pressure can also be achieved by any such engine having controllable intake manifold pressure.

Exhaust Valve Deactivation of Fewer Than All Cylinders and/or With Fueling Adjustment

This section generally describes combinations of EVD and fueling adjustments, with specific modes described in subsequent sections. Typically, the various exhaust valve deactivation (EVD) schemes described in this section, like those described above, are performed at mid to low loads, where it is desired to avoid excessively high air-fuel ratios and low exhaust temperatures, and to increase the effective load level of those cylinders operating in Standard Mode.

It is assumed that the engine's control unit 120 has appropriate hardware and software so that both EVD and fueling adjustments may be performed on a cylinder-by-cylinder basis. As explained above, various methods may be used to determine when to implement exhaust valve deactivation, such as by measuring or estimating exhaust temperature. The exhaust temperature threshold is predetermined and stored as part of the control system. The control system may compare current exhaust temperatures to the threshold, or the conditions in which a threshold is met may be determined by stored data such as look-up tables.

Exhaust valve deactivation methods may be implemented by deactivating the exhaust valves of fewer than all cylinders. In other words, in below-threshold engine conditions, some cylinders may operate in Standard Mode and the remaining cylinders may be EVD cylinders. The exhaust valves of EVD cylinders are activated with a reduced frequency, such as every 2^{nd}, 3^{rd}, or nth engine cycle, rather than on each engine cycle. For example, only one cylinder per cycle may be an EVD cylinder, with deactivation occurring every 2^{nd}, 3^{rd} or nth cycle.

Exhaust valve deactivation may be combined with fueling adjustments, with reduced fueling or no fuel at all. In one approach, EVD cylinders may be “non combusting cylinders” (not fueled). An “Air Spring Mode” described below uses this approach. In another approach, EVD cylinders may be combusting cylinders (are fueled) during each engine cycle but with reduced fueling. An “Internal EGR Mode” described below uses this approach.

When fewer than all cylinders participate in EVD, the choice of which cylinder(s) are EVD cylinders may be varied during engine operation. This facilitates thermal uniformity across the engine.

### Variable Speed Electric or Hydraulic Motor

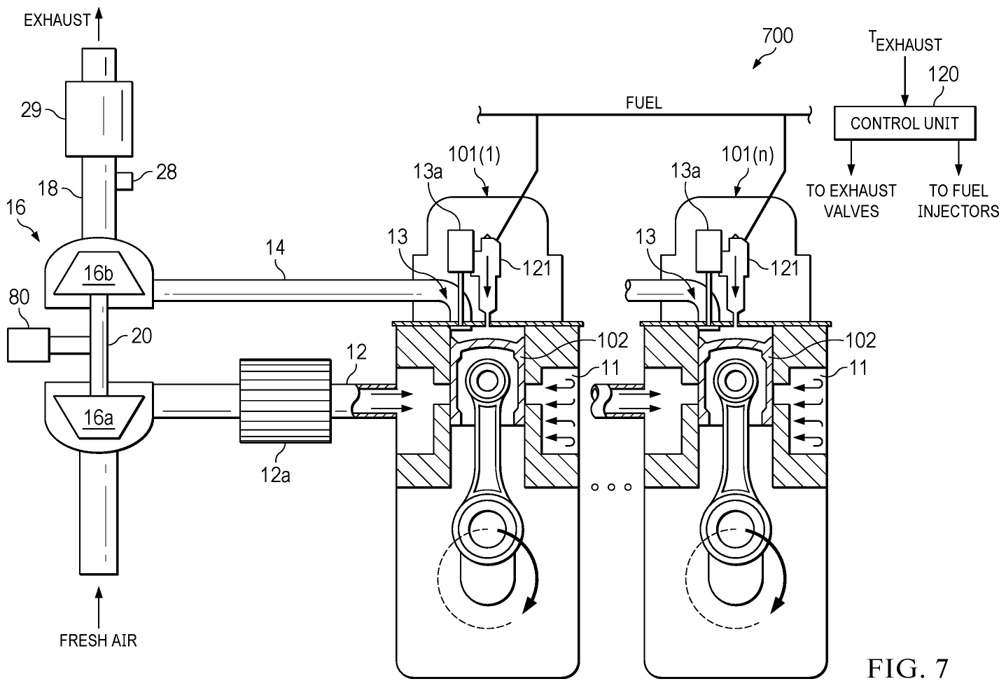

FIG. 7 illustrates an engine 700 like that of FIG. 1 but with a variable speed electric or hydraulic motor 80 to drive the compressor shaft 20.

For low loads, as described above, it may be desirable to reduce the compressor output. This will ensure unidirectional flow of air through the engine when exhaust valves are activated. The use of an electric motor rather than a mechanical drive for the compressor will improve fuel economy by reducing unnecessary pumping work.

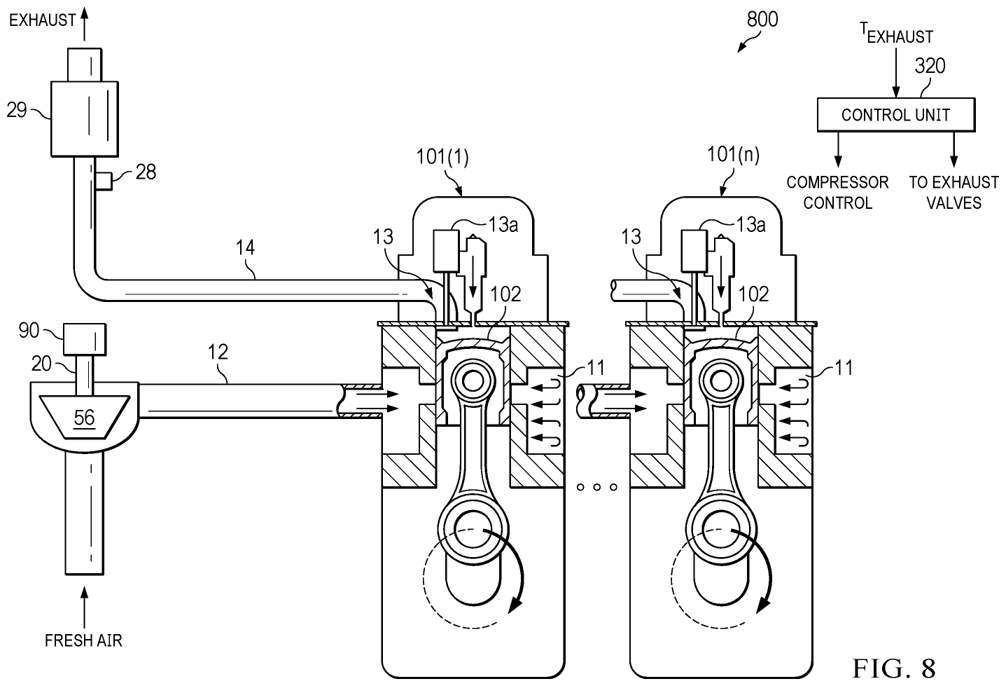

FIG. 8 illustrates an engine 800 like that of FIG. 5 but with a variable speed electric or hydraulic motor 90 to drive a supercharger rather than a turbocharger.

### Air Spring Mode

This section is directed to a specific cylinder operating mode, referred to herein as an “Air Spring Mode”. In this mode, the engine has fewer than all cylinders operating in Standard Mode (normal exhaust valve activation, which is once per cycle), as described above. The remaining cylinders have EVD and no fuel injected, thus acting as air springs.

Air Spring Mode is used in conditions when, if all cylinders were operating in Standard Mode, the exhaust temperature would be below a predetermined threshold. As a result of some cylinders operating in Air Spring Mode, cylinders operating in Standard Mode will have higher exhaust temperatures, achieving the goal of exceeding an exhaust temperature threshold that enables catalytic aftertreatment. Air Spring Mode may also be optionally used when the engine is above the exhaust temperature threshold for emissions or fuel advantages.

More specifically, when a cylinder is in Air Spring Mode, it has EVD and with no fuel injected. The number of Air Spring Mode cylinders may be incremented until the exhaust temperature from the reduced number of combusting cylinders exceeds the exhaust temperature threshold.

As an example, in a 16-cylinder engine, cylinders numbered 1-4 may operate in Standard Mode, with uniform fuel injected into each cylinder. Cylinders numbered 5-16 operate in Air Spring Mode (with EVD and no fuel injected). After some number of engine cycles, cylinders numbered 5-8, for example, change to Standard Mode, and cylinders numbered 1-4 and 9-16 become Air Spring Mode cylinders.

When some cylinders are operating in Air Spring Mode, there is uniform fueling of the Standard Mode cylinders. This fueling may be at the same level per cylinder as when all cylinders are in Standard Mode or may be at a higher level.

Selection of which cylinders are in Air Spring Mode or Standard Mode may be rotated around the engine to promote uniform operation across the entire engine over time. This schedule may vary from 1 engine cycle to X engine cycles.

Further, intake manifold air pressure may be regulated with a bypass to atmosphere with air spring mode to augment compressor speed control if needed. An example of how this may be implemented is illustrated in FIG. 6, using valve 61 to bleed off excess air.

Internal Exhaust Gas Recirculation (EGR) Mode This section is directed to a specific cylinder operating mode, referred to herein as an “Internal EGR Mode”, where EGR refers to exhaust gas recirculation. Internal EGR Mode, like Air Spring Mode, is used in conditions when, if all cylinders were operating in Standard Mode (discussed above), the exhaust temperature would be below a predetermined threshold. Internal EGR Mode may also be optionally used when the engine is above the exhaust temperature threshold for emissions or fuel advantages.

In this mode, the engine has fewer than all cylinders operating in Standard Mode (normal exhaust valve activation, which is once per cycle). The remaining cylinders are Internal EGR cylinders, having EVD and being fueled at low injection quantities, likely at a much lower frequency than each cycle. The fuel injection quantities may be approximately idle fuel quantities. It is also possible that fuel may not be injected on every cycle.

As a result of operating in Internal EGR Mode, cylinders have a portion of their combustion products blowing back into the air box when intake ports are uncovered, subsequently providing EGR to other cylinders. Any given cylinder will be able to operate continuously in Internal EGR Mode, provided that injection timing is implemented with enough cycles between subsequent injections that air exchange between that cylinder and the air box is sufficient to replenish the oxygen.

In operation, when engine condition are below the exhaust temperature threshold, one or more cylinders are switched to EVD. The number of EVD cylinders may be incremented until the exhaust temperature from the reduced number of combusting cylinders exceeds the preset threshold.

If an EVD cylinder is to operate as an Internal EGR cylinder, it has a reduced amount of fuel injected on one or more engine cycles. When cylinders are in Internal EGR Mode, the fueling level of the Standard Mode cylinders is uniform and may be reduced slightly.

When cylinders operate as EVD cylinders, Internal EGR Mode cylinders may operate in combination with Air Spring Mode cylinders. As an example for a 16-cylinder engine, cylinders 1-4 operate in Standard Mode, with uniform fuel injected into each cylinder. The fueling amount may be reduced to 95% of the Standard Mode amount. Cylinders 5-16 operate in EVD mode.

Of the EVD cylinders, one or more cylinders are in Air Spring Mode and the others are in Internal EGR Mode. In one example, cylinders numbered 5-8 operate with 5% of the fuel injection quantity of cylinders numbered 1-4 each cycle, and cylinders numbered 9-16 operate with no fuel injected.

In another example, of the EVD cylinders, Cylinders 5-8 operate for 1 cycle only with 5% of fueling for cylinders numbered 1-4, with cylinders numbered 9-16 operating with no fuel injected, followed by fueling switching to cylinders numbered 9-12 for the next cycle, with 5-8 and 13-16 without fuel, and so on.

What is claimed is:

1. A controller-implemented method of operating a two-cycle uniflow-scavenged engine, the engine having a number of cylinders, each cylinder having at least one exhaust valve(s), and the engine further having a predetermined exhaust gas temperature threshold, comprising:
defining a standard mode of cylinder operation such that a standard mode cylinder is a combusting cylinder with its at least one exhaust valve(s) activated with a standard frequency (every engine cycle);
defining an air spring mode of cylinder operation such that an air spring mode cylinder is a non-combusting cylinder with its at least one exhaust valve(s) activated with a reduced frequency relative to standard frequency;
if the current exhaust gas temperature is above the threshold exhaust gas temperature, optionally operating one or more cylinders as air spring mode cylinders and operating all remaining cylinders as standard mode cylinders;
if the current exhaust gas temperature is at or below the threshold exhaust gas temperature, operating one or more cylinders as air spring mode cylinders and the remaining cylinder(s) as standard mode cylinders.

2. The method of claim 1, further comprising rotating which cylinders operate as standard mode cylinders and which cylinders operate as air spring mode cylinders.

3. The method of claim 1, wherein if the current exhaust gas temperature is at or below the threshold exhaust gas temperature, the number of cylinders operating as air spring mode cylinders is incrementally increased until the temperature of exhaust from standard mode cylinders exceeds the exhaust temperature threshold.

4. The method of claim 1, wherein the engine is an Electro-Motive Diesel (EMD) engine.

5. The method of claim 1, wherein the engine further has a compressor, and further comprising the step of reducing the compressor mass air flow if the current exhaust gas temperature is at or below the threshold exhaust gas temperature.

6. The method of claim 1, wherein the engine is a locomotive engine and the threshold exhaust gas temperature occurs at Notch 4.

7. The method of claim 1, wherein the engine has an intake manifold, and further comprising regulating intake manifold air pressure with a bypass to atmosphere.

8. A controller-implemented method of operating a two-cycle uniflow-scavenged engine, the engine having a number of cylinders, each cylinder having at least one exhaust valve(s), and the engine further having a predetermined exhaust gas temperature threshold, comprising:
defining a standard mode of cylinder operation such that a standard mode cylinder is a combusting cylinder with its at least one exhaust valve(s) activated with a standard frequency (every engine cycle);
defining an internal exhaust gas recirculation (EGR) mode of cylinder operation such that an internal EGR mode cylinder is a combusting cylinder with a fueling rate at or below standard mode cylinder fueling and with its at least one exhaust valve(s) activated on a reduced frequency relative to the standard frequency;
if the current exhaust gas temperature is above the threshold exhaust gas temperature, optionally operating one or more cylinders as internal EGR cylinders and operating all remaining cylinders as standard mode cylinders;
if the current exhaust gas temperature is at or below the threshold exhaust gas temperature, operating one or more cylinders as internal EGR mode cylinders and the remaining cylinder(s), if any, as standard mode cylinders.

9. The method of claim 8, further comprising rotating which cylinders operate as standard mode cylinders and which cylinders operate as internal EGR mode cylinders.

10. The method of claim 8, wherein if the current exhaust gas temperature is at or below the threshold exhaust gas temperature, the number of cylinders operating as internal EGR mode cylinders is incrementally increased until the temperature of exhaust from standard mode cylinders exceeds the exhaust temperature threshold.

11. The method of claim 8, wherein the engine is an Electro-Motive Diesel (EMD) engine.

12. The method of claim 8, wherein the engine further has a compressor, and further comprising the step of reducing the compressor mass air flow if the current exhaust gas temperature is at or below the threshold exhaust gas temperature.

13. The method of claim 8, wherein the engine is a locomotive engine and the threshold exhaust gas temperature occurs at Notch 4.

14. An improved two-cycle uniflow-scavenged engine, the engine having a number of cylinders, each cylinder having at least one exhaust valve(s), and the engine further having a predetermined exhaust gas temperature threshold, comprising:
an actuator associated with each cylinder's exhaust valve(s) operable to activate and deactivate the exhaust valve(s);
a control unit programmed to control whether each cylinder operates as a standard mode cylinder or as an air spring mode cylinder;
wherein a standard mode cylinder is a combusting cylinder with its at least one exhaust valve(s) activated with a standard frequency (every engine cycle); and
wherein an air spring mode cylinder is a non-combusting cylinder with its at least one exhaust valve(s) activated with a reduced frequency relative to standard frequency.

15. The engine of claim 14, wherein the control unit further stores a predetermined exhaust gas temperature threshold and is further programmed to control whether the cylinders operate as standard mode cylinders or air spring mode cylinders based on whether the exhaust gas temperature threshold is not met.

16. An improved two-cycle uniflow-scavenged engine, the engine having a number of cylinders, each cylinder having at least one exhaust valve(s), and the engine further having a predetermined exhaust gas temperature threshold, comprising:
an actuator associated with each cylinder's exhaust valve(s) operable to activate and deactivate the exhaust valve(s);
a control unit programmed to control whether each cylinder operates as a standard mode cylinder or as an internal EGR (exhaust gas recirculation) mode cylinder;
wherein a standard mode cylinder is a combusting cylinder with its at least one exhaust valve(s) activated with a standard frequency (every engine cycle); and
wherein an internal EGR cylinder is a combusting cylinder with reduced fueling relative to a standard mode cylinder and with its at least one exhaust valve(s) activated on a reduced frequency relative to the standard frequency.

17. The engine of claim 16, wherein the control unit further stores a predetermined exhaust gas temperature threshold and is further programmed to control whether the cylinders operate as standard mode cylinders or internal EGR mode cylinders based on whether the exhaust gas temperature threshold is not met.

18. A controller-implemented method of operating a two-cycle uniflow-scavenged engine, the engine having a number of cylinders, each cylinder having at least one exhaust valve(s), and the engine further having a predetermined exhaust gas temperature threshold, comprising:
defining a standard mode of cylinder operation such that a standard mode cylinder is a combusting cylinder with its at least one exhaust valve(s) activated with a standard frequency (every engine cycle);
defining an air spring mode of cylinder operation such that an air spring mode cylinder is a non-combusting cylinder with its at least one exhaust valve(s) activated with a reduced frequency relative to standard frequency;
defining an internal exhaust gas recirculation (EGR) mode of cylinder operation such that an internal EGR mode cylinder is a combusting cylinder with a fueling rate at or below standard mode cylinder fueling and with its at least one exhaust valve(s) activated on a reduced frequency relative to the standard frequency;
if the current exhaust gas temperature is above the threshold exhaust gas temperature, optionally operating one or more cylinders as air spring mode cylinders and/or internal EGR cylinders and operating all remaining cylinders as standard mode cylinders;
if the current exhaust gas temperature is at or below the threshold exhaust gas temperature, operating one or more cylinders as air spring mode cylinders and/or internal EGR cylinders and the remaining cylinder(s) as standard mode cylinders.
